(19) United States
(12) Patent Application Publication
(10) Pub. No.: US 2013/0031180 A1
(43) Pub. Date: Jan. 31, 2013

(54) VIRTUAL IDENTITIES

(71) Applicants: Joerg Abendroth, Munchen (DE); Markus Bauer-Hermann, Munchen (DE); Robert Seidl, Konigsdorf (DE)

(72) Inventors: Joerg Abendroth, Munchen (DE); Markus Bauer-Hermann, Munchen (DE); Robert Seidl, Konigsdorf (DE)

(73) Assignee: NOKIA SIEMENS NETWORKS OY, Espoo (FI)

(21) Appl. No.: 13/639,546

(22) PCT Filed: Apr. 16, 2010
(86) PCT No.: PCT/EP2010/055048

§ 371 Date: Oct. 5, 2012

(51) Int. Cl. G06F 15/16

(52) U.S. Cl. 709/204

(57) ABSTRACT

A template is described that can be applied to user attribute data in order to generate a pseudonym/virtual identity for the user. The pseudonym includes a subset of the user's overall user attributes. The invention also enables a user to determine whether a particular pseudonym meets the requirements of a template by checking the pseudonym against a template provided, for example, by a service provider.

The invention relates to virtual identities or other pseudonyms, particularly (although not exclusively) for use in an online environment.

There is a trend for service providers and identity providers to collect increasing quantities of user related data (typically referred to as “user attributes”). There is also a trend for such user attributes to be more widely used in the Internet and in other virtual and online environments. Often, users agree to the collection and use of user attributes without restriction, since this can often be convenient. However, there are clear potential privacy concerns and many other users are not willing for user attributes to be collected and used without control.

The use of pseudonyms (such as InfoCards, virtual identities (VIDs) and transient identities) can at least partially address the privacy issue. In the present application, the term “pseudonym” is used to refer to identities, such as virtual identities and transient identities, that typically include a subset of a particular user's personal user attributes. Accordingly, the term “pseudonym” should be read to encompass terms such as virtual identity, transient identity and Microsoft Corporation's InfoCard (RTM).

A user may make use of different pseudonyms for different purposes. For example, an e-banking pseudonym may include user attributes such as the user's real name and the user's bank account details. A social network pseudonym may include the user's nickname and hobbies, but exclude attributes such as the user's real name and financial data.

The use of pseudonyms for controlling user privacy is particularly prevalent in Internet applications, but the use of pseudonyms is not solely limited to Internet and other online use.

A problem with pseudonyms is that they are not always easy to generate in a simple and flexible manner, particularly for non-expert users.

Pseudonyms can, for example, be generated by manually selecting which attributes are included in the pseudonym. This method is cumbersome and encourages users to apply course grained policies, such as “show all”. Of course, if all user attributes (including details that can identify the user) are included in a pseudonym, then that pseudonym does not succeed in protecting the identity and privacy of the user.

Accordingly, there remains a need to enable an average user to generate a pseudonym, where that user finds it too cumbersome to manually sort a plurality of digital attributes into a subset for use in the pseudonym, and may lack the skills needed to determine which attributes are needed in a particular circumstance and which attributes might have privacy-related consequences.

Identity managers (IDMs) can be used to automate (to some degree) the generation of pseudonyms. For example, an IDM may be preconfigured in a proprietary way to generate a pseudonym from a user's full list of user attributes. However, the use of only a limited number of IDM-generated pseudonyms is typically insufficiently flexible. Further, the proprietary nature of such an IDM solution may be unattractive to many users. Moreover, pseudonyms generated by one party (e.g. an IDM operator) are not always trusted by all relevant parties.

The present invention seeks to address at least some of the problems outlined above.

The present invention provides a method (for example, a method for generating a pseudonym) comprising: obtaining (for example by selecting) a source of attribute data for a user; obtaining (for example by selecting or downloading) a template (such as an XACML template) for use in generating a pseudonym for the user; and for each attribute available from said source of attribute data for the user, determining from the template whether or not or in which abstract way to include that attribute in said pseudonym.

The present invention also provides an apparatus (such as a file transformer/generator/editor, similar to an XML file transformer) comprising: a first input adapted to obtain (e.g. receive) attribute data for a user (for example, all available attribute data for that user or a pseudonym for a user); a second input adapted to obtain (e.g. receive) a template (such as an XACML template) for use in generating a pseudonym for the user (the template may, for example, be obtained (e.g. by downloading) from a service provider to which the user desires access); and a processor adapted to determine, for each attribute included in the attribute data for the user, whether or not to include that attribute in said pseudonym. The apparatus may further comprise an output for outputting the said pseudonym. The apparatus may be provided at a user terminal. The apparatus may be provided as part of a user browser. The apparatus may be provided as part of an identity management system.

The attribute data for the user may comprise all available attribute data for that user. Alternatively, the attribute data for the user may be obtained from a pseudonym for the user, such that pseudonym can be generated iteratively.

In some forms of the invention, the template is obtained from a service provider to which the user desires access. The template may alternatively be provided by an online community. Trade organisations, government bodies etc. can also provide templates. A mechanism may be provided for generating templates (typically automatically) on the basis of the actions of one or more users. In some forms of the invention, a graphical user interface is provided that enables a user to select a template. The graphical user interface may allow a user to upload a template, to select a template from a list of stored templates, to select a template from a list of providers or to insert a URL from where a template can be downloaded.

The invention may also include a fuzzing (or modifying) function, wherein at least one of said attributes available from said source of attribute data for the user is modified (for example by being replaced with an approximation of the attribute or some other less precise attribute) before being included in said pseudonym. A second processor (which may or may not be the same physical processor as the first processor referred to above) may be provided that is adapted to modify at least some of said attribute data for said user (for example by being replaced with an approximation of the attribute or some other less precise attribute) before including said attribute data in said pseudonym.

The invention also provides a method comprising: obtaining a proposed pseudonym for a user; comparing the proposed pseudonym with a template for use in generating pseudonyms, wherein the comparison step provides an output indicating the extent to which the proposed pseudonym is in accordance with the said template. The method may include obtaining the said template, for example by receiving the template at an input or downloading the template.

The invention further provides an apparatus (such as a checker tool) comprising: a first input adapted to receive a proposed pseudonym for a user; and a processor adapted to compare the proposed pseudonym with a template for use in generating pseudonyms, wherein the processor provides an output indicating the extent to which the proposed pseudonym is in accordance with the said template. The apparatus may have an additional input for receiving the said template.

Comparing the proposed pseudonym with the template may include obtaining a temporary pseudonym for the user, wherein the temporary pseudonym is generated by applying said template to a first set of user attributes for said user and comparing the proposed pseudonym with the temporary pseudonym. The step of obtaining said temporary pseudonym may comprise generating the said temporary pseudonym; by way of example, the processor adapted to carry out the comparison step described above may also carry out the said generating step.

Alternatively, the temporary pseudonym may be received, for example at a second input of the apparatus of the invention.

In many forms of the invention, the said temporary pseudonym is generated from the full set of user attributes of the user.

The present invention also provides a method comprising: obtaining a first template for use in generating pseudonyms;

obtaining a second template for use in generating pseudonyms; and comparing the first and second templates to determine whether (or the extent to which) the second template meets the requirements of the first template.

The present invention further provides an apparatus comprising: a first input adapted to obtain (e.g. receive) a first template (such as an XACML template) for use in generating pseudonyms; a second input adapted to obtain (e.g. receive) a second template (such as an XACML template) for use in generating pseudonyms; and a processor adapted to compare the first and second templates to determine whether (or the extent to which) the second template meets the requirements of the first template.

In some forms of the invention, the comparison of the first and second templates comprises: using the first template to generate a first pseudonym from a set of user attributes (e.g. a full set of the user attributes for a user); using the second template to generate a second pseudonym from said set of user attributes; and comparing the first and second pseudonyms.

The present invention also provides a computer program comprising: code (or some other means) for obtaining a source of attribute data for a user; code (or some other means) for obtaining a template for use in generating a pseudonym for the user; and code (or some other means) for determining from the template, for each attribute available from said source of attribute data for the user, whether or not to include that attribute in said pseudonym. The computer program may be a computer program product comprising a computer-readable medium bearing computer program code embodied therein for use with a computer.

The present invention further provides a computer program comprising: code (or some other means) for obtaining a proposed pseudonym for a user; and code (or some other means) for comparing the proposed pseudonym with a template for use in generating pseudonyms, wherein the comparison step provides an output indicating the extent to which the proposed pseudonym is in accordance with the said template. The computer program may be a computer program product comprising a computer-readable medium bearing computer program code embodied therein for use with a computer.

The present invention yet further provides a computer program comprising: code (or some other means) for obtaining a first template for use in generating pseudonyms; code (or some other means) for obtaining a second template for use in generating pseudonyms; and code (or some other means) for comparing the first and second templates to determine whether (or the extent to which) the second template meets the requirements of the first template. The computer program may be a computer program product comprising a computer-readable medium bearing computer program code embodied therein for use with a computer.

Exemplary embodiments of the invention are described below, by way of example only, with reference to the following numbered schematic drawings.

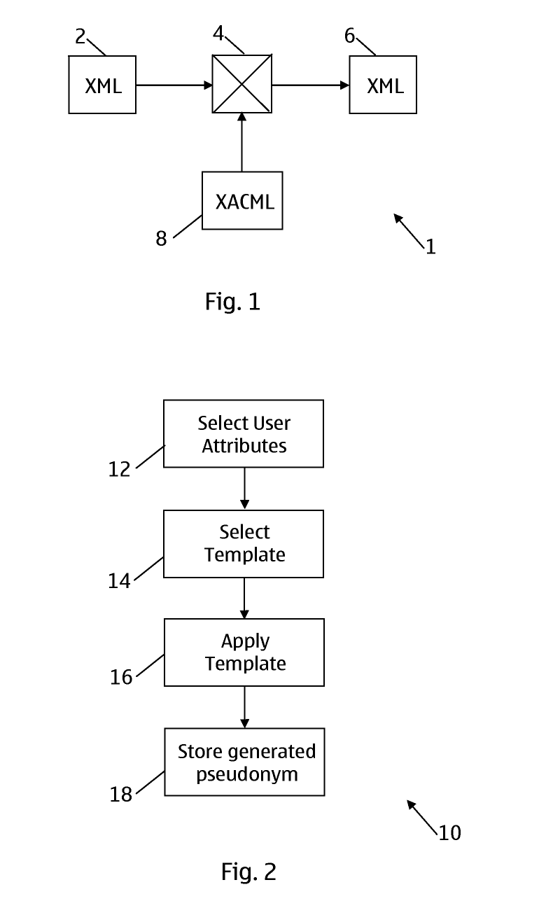

FIG. 1 is a block diagram showing a system in accordance with an aspect of the present invention;

FIG. 2 is a flow chart showing an algorithm in accordance with an aspect of the present invention;

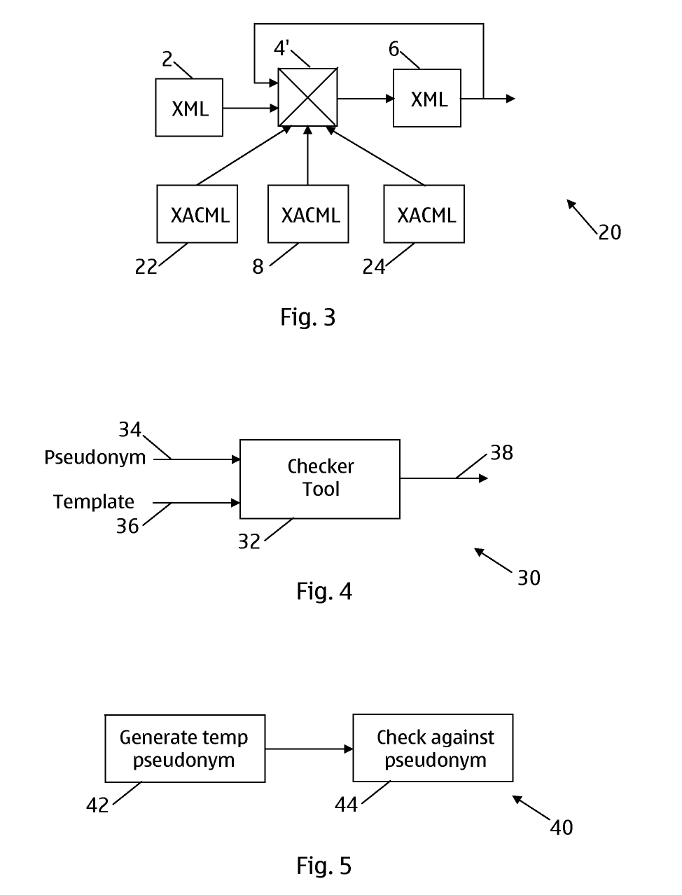

FIG. 3 is a block diagram showing a system in accordance with an aspect of the present invention

FIG. 4 is a block diagram showing a system in accordance with an aspect of the present invention;

FIG. 5 is a flow chart showing an algorithm in accordance with an aspect of the present invention;

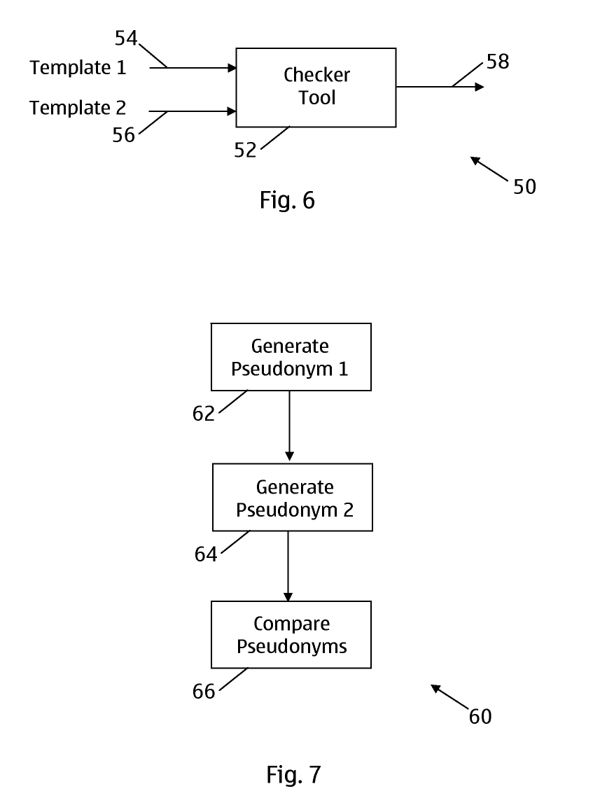

FIG. 6 is a block diagram showing a system in accordance with an aspect of the present invention; and

FIG. 7 is a flow chart showing an algorithm in accordance with an aspect of the present invention

The present invention provides a template (such as an extensible access control markup language (XACML) template) that can be applied to identity data (such as user attribute data) in order to generate a pseudonym (or virtual identity). The pseudonym includes a subset of the user attributes included in the initial identity data.

FIG. 1 is a block diagram of a system, indicated generally by the reference numeral 1, in accordance with an aspect of the present invention. The system comprises a first XML (extensible markup language) file 2, a second XML file 6, an XACML-based template 8 and an XML file transformer 4 (or some other mechanism) for creating the second XML file 6.

The first XML file 2 contains user attribute data. Typically, the XML file 2 contains all of the user attribute data for a particular user although, as described further below, this is not essential to all embodiments of the invention. The second XML file 6 provides the pseudonym (or virtual identity) for the user and includes a subset of the attributes included in the XML file 2.

The XACML template 8 defines how the XML file 2 is modified to generate the XML file 6. XACML is a known access control language that can be used to define rules for providing and denying access. XACML is implemented using XML and is therefore ideally suited for generating the XML file 6. The XACML template 8 is applied to the XML file 2 as indicated using the XML file transformer 4 in FIG. 1, in a manner that is well known in the art.

FIG. 2 is a flow chart showing an algorithm, indicated generally by the reference numeral 10, in accordance with an aspect of the present invention. The algorithm 10 is used to generate a pseudonym for a user that includes a subset of the overall user attributes for the user.

The algorithm 10 starts at step 12 where the user attributes from which the subset of user attributes will be selected is obtained. The user attributes selected at step 12 may be all of the available attributes for the user as stored, for example, at an identity management system. As indicated above with respect of the system 1, the user attributes selected at the step 12 may be provided in the form of an XML file.

Next, at step 14, a template (such as the XACML template 8) for generating the pseudonym is selected. A plurality of different templates may be available for different purposes. By way of example, a user may have access to different service providers, each having different rules regarding user attribute requirements. A different template may be provided for generating pseudonyms for each of those service providers.

The step 14 may be implemented using a graphical user interface. The graphical user interface may allow a user to obtain a template in one or more of the following ways: upload a template; select a template from a list of stored templates; select a template from a list of providers; or insert a URL from where a template can be downloaded.

The algorithm 10 then moves to step 16, where the selected template is applied. Thus, in the system 1, the second XML file 6 is generated at the step 16. The step 16 may be carried out by importing the template selected at step 14 into an file transformer (such as the file transformer 4) or some other means for generating or editing a file and using the file transformer to generate a specific policy setting for a specific user based on the definitions given in the template.

Finally, the algorithm 10 ends (at step 18) with the generated pseudonym being stored.

By way of example, the user may have attributes regarding his different hobbies and work activities stored at an IDM. Some examples are: current weekly working hours count, golf handicap; favourite orienteering courses; and the name of an orienteering team the user belongs to.

A separation of duty suggests keeping the different pseudonyms apart, meaning that when the user visits orienteering sites he will not show either his golf handicap or his weekly working hours count. An orienteering site template may be provided that allows the IDM to filter out the required attributes (relating to orienteering) and show no other attributes. The editor may belong to a trusted site, e.g. a national orienteering community. If a user accesses an online sports shop and uses the orienteering template to provide user attributes, the sports shop will receive orienteering-related attributes, but the user will not be recognizable to the sports shop as golf player, thereby respecting the user's privacy.

The application of the template to the user attributes can be implemented in a number of ways. The following methods are provided by way of example only. The skilled person will be aware of many other possibilities.

A processor device, such as the XML file transformer 4, may obtain the user attributes (e.g. the first XML file 2) as a first input, and a template (e.g. the XACML template 8) as a second input and compute a pseudonym (e.g. the second XML file 6) as an output. The functionality of the processing device could be provided at the user's terminal or at a browser.

An identity management system (IDM) could be provided as a relying party (RP). The IDM awaits a request for a pseudonym. The IDM then queries a database to lookup the user's attributes (e.g. in the form of the first XML file 2). A processing function at the IDM (implementing the functionality of the XML file transformer 4) selects a sub-set of attributes for inclusion in a pseudonym.

The XML file transformer 4 may include a fuzzing (or modifying) function, such that at least some of the attributes are “fuzzed”. This enables a user to provide attribute data that is less precise than the full attribute data, for example for privacy reasons. By way of example, instead of including the precise address of a user in a pseudonym, a location fuzzing would be allowed (e.g. district or town/city or country only). A mechanism (such as an IDM) could be used to check if what is included in a pseudonym (the less precise “fuzzed” data) is correct. The use of “fuzzed” data further improves the privacy of the user by restricting the precision of potentially sensitive data that is provided to third parties.

The template used to convert the user attributes into a pseudonym for the user can be generated in a number of ways. For example, a particular service provider may provide a template that defines the user attributes required by the service provider. Alternatively, templates can be generated by an online community. In many circumstances, a user may trust that a template generated by the online community has a reasonable level of privacy protection. A community-generated template (e.g. a template generated by a particular social networking community) may serve as a default template for the community, in the sense of being broadly accepted as providing a reasonable level of privacy for users and a reasonable level of utility for service providers.

Of course, there are many other potential sources of templates. Some exemplary potential sources are listed below, although many other possibilities will be apparent to the skilled person.

1. Online communities that seek to protect consumers, such as the Electronic Frontier Foundation (EFF).

2. Communication service providers wanting to protect their customers.

3. Templates derived (possibly automatically) from groups of users (sometimes referred to as privacy-conscious users).

4. Government-provided templates. For example, some services need to check the age of users accessing the services. Such requirements could be specified in templates provided by governments or similar organisations.

5. Templates derived (possibly automatically) from a manually generated pseudonym of one user.

6. Services that wants to announce what kind of identity data is required to use the service.

7. Communities of similar organisations (e.g. sports clubs) that define what attributes members should have in (and/or should exclude from) their profiles.

8. Trade organisations.

As described above, the present invention enables a user to download (or otherwise obtain) a template and to apply that template to his full user data in order to generate a pseudonym. It is not, however, essential for a particular template to be applied to the full user data. A template could, for example, be applied to an existing pseudonym.

FIG. 3 is a block diagram of a system, indicated generally by the reference numeral 20, in accordance with an aspect of the present invention. The system 20 includes the first XML file 2, the second XML file 6 and the XACML-based template 8 of the system 1. The system 20 also includes an XML file transformer 4′ that is similar to the file transformer 4 of the system 1. The system 20 further includes a second XACML-based template 22 and a third XACML-based template 24. The templates 22 and 24 are similar to the template 8.

In common with the XML file transformer 4, the XML file transformer 4′ has a first input for receiving the XML file 2 and a second input coupled to the XACML template 8. The XML file transformer 4′ also has a third input adapted to receive the second XML file 6 and fourth and fifth inputs that are coupled to the templates 22 and 24 respectively.

In use, the XML file transformer 4′ is adapted to generate the second XML file 6 on the basis of either the first XML file 2 or the existing XML file 6. Thus, the XML file 6 can be generated in an iterative manner. The XML file transformer 4′ is also adapted to select any one of the templates 8, 22 and 24 for use in generating the second XML file 6. Thus, the file transformation carried out by the XML file transformer 4′ is on the basis of one of the available templates.

Thus, in common with the XML file transformer 4, the XML file transformer 4′ is able to use the template 8 to generate the XML file 6 from the XML file 2. However, the XML file transformer 4′ is also able to select a different template and is also able to apply a selected template to an existing pseudonym (the XML file 6) to generate a second pseudonym.

In some exemplary embodiments of the invention, the first XML file 2 contains the full user attribute data for a particular user. As described above, the second XML file 6 provides a pseudonym (or virtual identity) for the user and includes a subset of the attributes included in the XML file 2, with that pseudonym being generated under the control of the first XACML template 8. The pseudonym 6 can be further modified by the XML file transformer 4′ on the basis of a different template (such as the template 22 or the template 24) to generate a different pseudonym that is a subset of the user attributes included in the original version of the second XML file 6.

In one exemplary use of the system 20, a user may define (or obtain) the first template 8 and use that template to generate a first pseudonym that omits user attributes that the user is not willing to provide to any service provider. A second template 22 may be provided by a service provider that defines the user attributes that are required by the service provider. In this way, the second pseudonym generated by the XML file transformer 4′ includes only those user attributes that are required by the service provider (as defined by the template 22) and that the user is willing to provide (as defined by the template 8).

Of course, more or fewer than the three templates shown in the system 20 may be provided in a particular embodiment of the invention. Furthermore, the system 20 is flexible and can generate a pseudonym in an iterative manner, such that many templates may be applied before a final pseudonym is generated.

As described above, the present invention can be used to create pseudonyms for a user. However, the principles of the present invention can be applied for other purposes, as described further below.

FIG. 4 is a block diagram showing a system, indicated generally by the reference numeral 30, in accordance with an aspect of the present invention. The system 30 comprises a checking tool 32. As described in detail below, the checking tool 32 can be used to determine whether or not a particular pseudonym meets the requirements of a particular template.

The checking tool 32 has a first input 34 adapted to receive a pseudonym. The pseudonym may, for example, be generated by a user and the user may wish to determine whether or not the pseudonym meets the requirements of a particular template. The checking tool 32 has a second input 36 adapted to receive a template. The checking tool takes the pseudonym and template data and determines whether or not the pseudonym meets the requirements of the template.

The checking tool 32 has an output 38 for indicating whether (and possibly the extent to which) the pseudonym meets the requirements of the template. By way of example, the output 38 may provide a red/green output (or perhaps a yes/no output), in which a red output indicates that one or more user attributes deemed to be mandatory to the template are missing from the pseudonym and a green output indicates that all user attributes deemed to be mandatory in the template are provided by the pseudonym. Further, a red/amber/green output might be provided, in which the amber output might, for example, indicate that a significant number, but not all, of the required attributes are missing.

The functionality of the checker tool 32 could be implemented in a number of ways. FIG. 5 is a flow chart showing an exemplary algorithm, indicated generally by the reference numeral 40, for implementing the functionality of the checker tool 32.

The algorithm 40 starts at step 42, where the full user attribute data for the user and the template against which the user's pseudonym is to be checked (the template received at the input 36) are used to generate a temporary pseudonym for the user. Next, at step 44, the temporary pseudonym is checked against the pseudonym that has been generated by the user (the pseudonym received at the input 34).

By way of example, consider a situation in which a user has 5 attributes (A, B, C, D and E). A pseudonym that the user is considering using with a particular service includes the attributes A, B and C, but omits the attributes D and E. Assume that the service provider provides a template that can be used to generate pseudonyms suitable for use with that service. As described above, the template can be applied to the user's full user attributes to generate a temporary pseudonym.

The temporary pseudonym can now be compared with the pseudonym that the user is considering using. If the temporary pseudonym includes attributes not included within the pseudonym that the user is considering using, then that pseudonym is not in accordance with the template. For example, if the temporary pseudonym includes the attributes A, B, C and E, or if the temporary pseudonym includes the attributes B, C and D, then the pseudonym that the user is considering using (including only the attributes A, B and C) is not in accordance with the template.

The present invention can also be used to determine whether a first template is in accordance with a second template.

FIG. 6 is a block diagram showing a system, indicated generally by the reference numeral 50, in accordance with an aspect of the present invention. The system 50 comprises a checking tool 52. The checking tool 52 has a first input 54 adapted to receive a first template and a second input 56 adapted to receive a second template. The checking tool 52 also has an output 58 for indicating whether (and possibly the extent to which) the first template is in accordance with the second template.

FIG. 7 is a flow chart showing an exemplary algorithm, indicated generally by the reference numeral 60, for implementing the functionality of the checker tool 52.

The algorithm 60 starts at step 62, where the full user attribute data for the user and the first template (as received at the input 54) are used to generate a first pseudonym for the user. Next, at step 64, the full user attribute data for the user and the second template (as received at the input 56) are used to generate a second pseudonym for the user.

Finally, at step 66, the first and second pseudonyms are compared to determine whether they are compatible with one another. By way of example, the output 58 may provide a red/green output (or perhaps a yes/no output), in which a red output indicates that one or more user attributes are included in the first pseudonym that are not included in the second pseudonym and a green output indicates that all the user attributes included in the first pseudonym are also included in the second pseudonym.

By way of example, consider a situation in which a user wants to compare a template provided by a service provider that defines the attributes that need to be disclosed to the service provider with a template provided by an online community that provides a default template that is suggested by the community as providing a reasonable level of privacy for users and a reasonable level of utility for service providers. Assume that the service provider template is received at the input 54 and that the community template is received at the input 56.

Consider a situation in which a user has 5 attributes (A, B, C, D and E). The community template (received at the input 56) indicates that, for privacy reasons, only attribute B should be communicated in full and that attribute C should be fuzzed. Thus, the pseudonym generated at step 62 of the algorithm 60 includes the attribute B and a fuzzed version of the attribute C, but does not include any of the attributes A, D and E.

Assume that in a first embodiment of the invention, the service provider template (received at input 54) requires the user attributes A, B and D to be provided. Thus, the pseudonym generated at step 64 of the algorithm 60 includes the attributes A, B and D. In this event, the user, upon checking whether the service generated pseudonym is privacy respecting according to the community recommendation, will get the red output because the community recommendation template indicates that attributes A and D should not be shown.

Assume that in a second embodiment of the invention, the service provider template (received at input 54) requires that only the user attributes B be provided. Thus, the pseudonym generated at step 64 of the algorithm 60 includes only the attribute B. In this event, the user, upon checking whether the service generated pseudonym is privacy respecting according to the community recommendation, will get a green output because the community recommendation template indicates that service provider template is privacy respecting.

Of course, the comparison of the first and second templates could be implemented in other ways.

The embodiments of the invention described above have included user attributes provided in XML files and templates provided as XACML templates. Neither the use of XML files nor the use of XACML templates is essential to all embodiments of the invention. The skilled person will be aware of alternative implementations of the principles of the present invention.

For example, the XML files 2, 6 and 8 described above with reference to FIG. 1 could, in fact, be XACML files. Alternatively, those files could be implemented as JavaScript Object Notation (JSON) files or Identity Objects. The templates 8, 22 and 24 described above with reference to FIGS. 1 and 3 could be implemented as XSLT (XSL transformations).

Other possible implementations will be apparent to those skilled in the art.

Further, instead of templates, the full set of attributes could be used. For example, a user could provide an identity object to a community site (that contains, typically, all the user attributes for that user) and a restricted identity object could be returned, perhaps handpicking the attributes or using the elements described in the present invention to generate the restricted identity object using a template.

Also, a first identity management system (IDM) could store and provide the full user attribute data for a particular user. A second identity management system (IDM) could be provided to perform filtering, so that all requests of the first IDM go through the second IDM (or that the second IDM retrieves a pseudonym from the first IDM and stores a new pseudonym to the first IDM after filtering).

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
obtaining a source of attribute data for a user;
obtaining a template for use in generating a pseudonym for the user; and
for each attribute available from said source of attribute data for the user, determining from the template whether or not to include that attribute in said pseudonym.

2. A method as claimed in claim 1, wherein the attribute data for the user comprises all available attribute data for that user.

3. A method as claimed in claim 1, wherein the attribute data for the user is obtained from a pseudonym for the user.

4. A method as claimed in claim 1, wherein said template is obtained from a service provider to which the user desires access.

5. A method as claimed in claim 1, further comprising a modifying function, wherein at least one of said attributes available from said source of attribute data for the user is modified before being included in said pseudonym.

6. An apparatus comprising:
a first input adapted to obtain attribute data for a user;
a second input adapted to obtain a template for use in generating a pseudonym for the user; and
a processor adapted to determine, for each attribute included in the attribute data for the user, whether or not to include that attribute in said pseudonym.

7. An apparatus as claimed in claim 6, wherein the apparatus is provided at a user terminal.

8. An apparatus as claimed in claim 6, wherein the apparatus is provided as part of a user browser.

9. An apparatus as claimed in claim 6, wherein the apparatus is provided as part of an identity management system.

10. An apparatus as claimed in claim 6, further comprising a second processor adapted to modify at least some of said attribute data for said user before including said attribute data in said pseudonym.

11. A method comprising:
obtaining a proposed pseudonym for a user;
comparing the proposed pseudonym with a template for use in generating pseudonyms, wherein the comparison step provides an output indicating the extent to which the proposed pseudonym is in accordance with the said template.

12. A method as claimed in claim 11, wherein said comparing step comprises obtaining a temporary pseudonym for the user, wherein the temporary pseudonym is generated by applying said template to a first set of user attributes for said user and comparing the proposed pseudonym with the temporary pseudonym.

13. An apparatus comprising:
a first input adapted to receive a proposed pseudonym for a user; and
a processor adapted to compare the proposed pseudonym with a template for use in generating pseudonyms, wherein the processor provides an output indicating the extent to which the proposed pseudonym is in accordance with the said template.

14. An apparatus as claimed in claim 13, wherein said processor is adapted to:
generate a temporary pseudonym for the user, wherein the temporary pseudonym is generated by applying said template to a first set of user attributes for said user; and
compare the proposed pseudonym with the temporary pseudonym.

15. An apparatus as claimed in claim 13, further comprising a second input for receiving the said temporary pseudonym.

16. An apparatus as claimed in claim 13, wherein the temporary pseudonym is generated from the full set of user attributes of the user.

17. A method comprising:
obtaining a first template for use in generating pseudonyms;
obtaining a second template for use in generating pseudonyms; and
comparing the first and second templates to determine whether the second template meets the requirements of the first template.

18. A method as claimed in claim 17, wherein comparing the first and second templates comprises:
using the first template to generate a first pseudonym from a set of user attributes;
using the second template to generate a second pseudonym from said set of user attributes; and
comparing the first and second pseudonyms.

19. A computer program product comprising:
means for obtaining a source of attribute data for a user;
means for obtaining a template for use in generating a pseudonym for the user; and
means for determining from the template, for each attribute available from said source of attribute data for the user, whether or not to include that attribute in said pseudonym.

20. A computer program product comprising:
means for obtaining a proposed pseudonym for a user; and
means for comparing the proposed pseudonym with a template for use in generating pseudonyms, wherein the comparison step provides an output indicating the extent to which the proposed pseudonym is in accordance with the said template.
